(19) United States
(12) Patent Application Publication
(10) Pub. No.: US 2012/0039456 A1
(43) Pub. Date: Feb. 16, 2012

(54) METHODS AND APPARATUSES RELATED TO A TELEPHONE CALL COMPLETION SERVICE

(76) Inventors: Andrew Frank Conner, Melbourne, FL (US); David Speed Ream, Indian Harbor Beach, FL (US)

(21) Appl. No.: 13/182,427

(22) Filed: Jul. 13, 2011

Related U.S. Application Data
(60) Provisional application No. 61/367,439, filed on Jul. 25, 2010.
(60) Provisional application No. 61/363,948, filed on Jul. 13, 2010.

(51) Int. Cl. H04M 3/436

(52) U.S. Cl. 379/201.11

(57) ABSTRACT

The present embodiments describe methods and apparatuses for protecting the privacy of one or both parties involved in a two-party telephone conversation. The embodiments also use an SMS text network to provide advance, substantial, customizable information to a recipient prior to the joining of two parties in conversation. The embodiments also provide dynamic control over who responds to an incoming call based on multiple criteria. The invention uses SIP various forms of VoIP technology to determine and route calls incoming to a communications system and sends advance notification(s) to recipient(s) prior to the joining the parties for conversation.

### CROSS-REFERENCE TO RELATED APPLICATIONS

This application claims the benefit of Provisional Application No. 61/367439 filed Jul. 13, 2010 and Provisional Application No. 61/363948 filed Jul. 25, 2010. The contents of these two provisional applications are incorporated by reference herein as if present in the current application.

### FIELD OF THE INVENTION

This invention relates to privacy protection, identity verification and advance information notification related to the use of the public telephone networks.

### BACKGROUND OF INVENTION

The public switched telephone network (PSTN) is ubiquitous in its expansive coverage and essential for completing a telephone call between two individuals. Although the burgeoning wireless mobile phone network is nearly as pervasive, it too relies on certain features and devices of the PSTN. However, there are known disadvantages associated with the PSTN and its interaction with mobile and fixed wireless networks. The various presented embodiments address and resolve certain of these disadvantages.

### BRIEF DESCRIPTION OF THE DRAWINGS

The presented embodiments can be more easily understood and the advantages and uses thereof more readily apparent when the following detailed description is read in conjunction with the associated figures. The figures are conceptual with emphasis on clarity and are not drawn to scale, but are drawn to emphasize specific features relevant to the inventions. Like reference characters denote like elements throughout the figures and text.

FIGS. 1 and 2 illustrate conceptual representations of two embodiments of the invention.

FIGS. 3, 4 and 5 are block diagrams of certain elements associated with various embodiments of the invention.

FIGS. 6 and 7 are flowcharts of different embodiments.

FIG. 8 is a conceptual representation of an embodiment of the invention.

FIG. 9 is a flowchart of a credit card transaction approval embodiment of the present invention.

### DETAILED DESCRIPTION

Before describing in detail the particular methods and apparatuses related to a telephone call completion service, it should be observed that embodiments presented herein include a novel and non-obvious combination of elements and method steps. So as not to obscure the disclosure with details that will be readily apparent to those skilled in the art, certain conventional elements and steps have been presented with lesser detail.

The presented embodiments are not intended to define limits of the structures, elements or methods of the inventions, but only to provide example constructions. The embodiments are permissive rather than mandatory and illustrative rather than exhaustive.

Generally, the presented embodiments relate to providing privacy protection, maintaining anonymity of the calling parties, verifying identity, and providing advance information notification, all related to use of public telephone networks (i.e., wherein at least a segment of a call passes through a public switched telephone network, where other segments may pass through networks, such as a cellular mobile network and the Internet). In addition, SMS text networks may be used to pre-notify a called party of the arrival and content of public switched-telephone network (PSTN) calls prior to joining two call legs to form a complete call circuit that joins the calling and called parties. Computer servers, VoIP devices, telephone bridging devices, databases and other computer-type devices can be used to implement the features of the various presented embodiments.

The presented embodiments provide desirable technical features as related to call processing using various telecommunications devices and services. The embodiments may be useful for protecting personal and/or business privacy and for providing efficient techniques to connect potential customers with businesses. One embodiment also affords both personal and business users advance information of an incoming call prior to joining the two parties into a single call.

Certain of the embodiments refer to a database as one element of the embodiment. The database stores all the various phone numbers, PINS, IDNs, customer account information, etc. required to perform the various activities of the systems of the embodiments. The database may reside in the system, as a stand-alone database on the Internet, or in any another appropriate location. The database is updated dynamically as customers and customer information and preferences are added or deleted. The databases can be organized and searched according to the various known techniques for accomplishing these tasks. A data response may be any returned data from the database that contains the results requested or implied by the associated request.

Certain of the presented embodiments describe a method whereby a person (called party) may receive a phone call or text message from another person (calling party) without the calling party knowing the called party's actual published (or unpublished) directory number or SMS text number. Optionally, the called party may also be kept ignorant of the calling party's identifying directory number or SMS text number.

### Embodiment 1

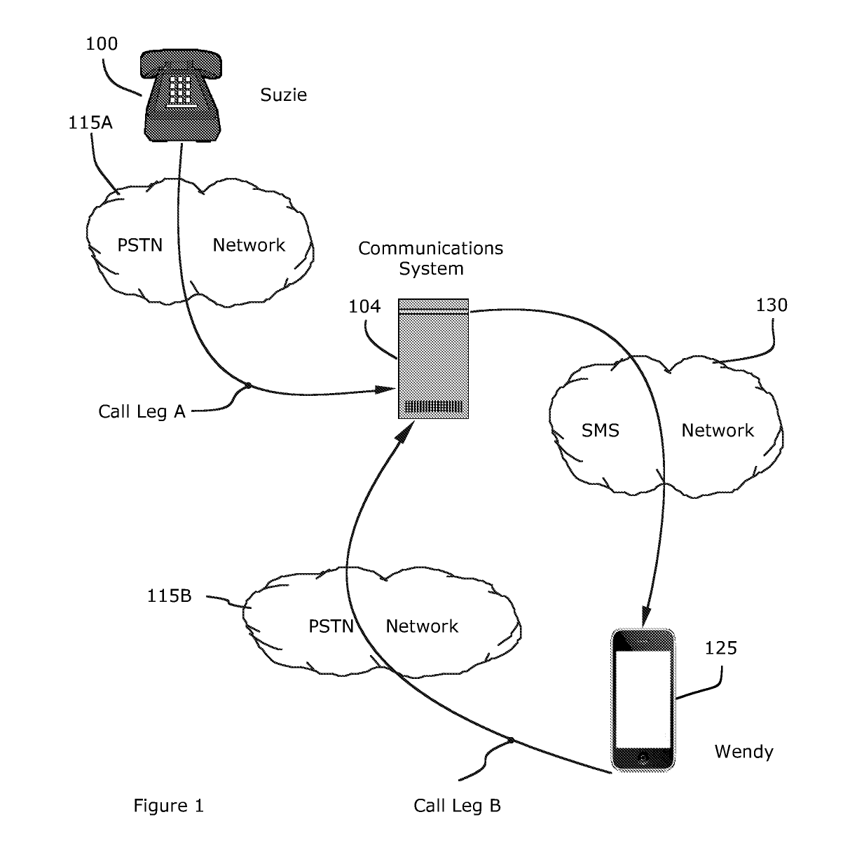

In this embodiment, referencing FIG. 1, Suzie, using a communications device 100 (illustrated as a land line telephone, for example, but the communications device can also comprise a mobile telephone, a smart phone, a personal digital assistant, a satellite phone, a ship-to-shore phone a VOIP phone or any other devices for connecting through the PSTN) calls a communications system 104, through a PSTN network 115A, thereby setting up a call leg A. To call the communications system, Suzie may use an inbound directory number (IDN) assigned to Wendy or another number that will connect Suzie to a line assigned to Wendy.

Suzie places the call by entering a telephone number and believes she is placing a call directly to a party to whom she desires to talk. Suzie does not realize that she is in fact placing a call to the communications system 104. After Suzie's call is connected to the communications system 104, Suzie enters a PIN on the keypad of the communications device 100. The PIN was previously assigned and is associated with the purpose of Suzie's call or is associated with the person Suzie wishes to talk to.

Prior to Suzie's call, Wendy had subscribed to or enrolled with a service that operates the communications system 104. This subscription can be initiated through a subscription website, by mail, or through participating newspapers and organizations, for example. Wendy can pay for the service through the website or via a participating partner. Upon becoming a subscriber, the service issued a unique PIN to Wendy and added an entry into a database that associated Wendy with her assigned PIN. The PIN comprises a multi-digit numeric or alphanumeric pseudo-identity number™ (PsIN™) and for certain embodiments may also be assigned a multi-digit inbound directory number (IDN) for use by Suzie as described above.

The communications system 104 receives and decodes the PIN. By consulting its database, the communications system 104 determines that the entered PIN (and/or the IDN number) is associated with Wendy. The communications system 104 can determine this association by simply using the PIN as an index into the database. Other schemes for associating the PIN with Wendy are known by those skilled in the art and may be implemented in to accomplish this association.

After the communications system 104 processes the entered PIN, it creates and sends an SMS text message to Wendy's communications device 125 through an SMS network 130. The communications system 104 can use other techniques for contacting Wendy, such as by placing a telephone call to a second communications device used by Wendy. While contacting Wendy, the communications system 104 can place Suzie on hold through a conference bridging device.

The SMS text message may comprise a message that a calling party is waiting, a call back number for Wendy to use in calling into the system, and the calling party's telephone number.

Wendy receives the SMS text message and calls the number (a call-back number) set forth in the SMS text message via the PSTN network 115B. This action sets up a call leg B to the communications system 104. Alternatively, Wendy may have a call back number assigned to her for the purpose of calling the system and therefore it is not necessary for the text message to include a call-back number for Wendy.

The communications system 104 then joins call leg A and call leg B to join Suzie and Wendy in a complete call circuit, i.e., into a telephone conversation.

In either case, before answering an incoming phone call (i.e., either the initial incoming call from Suzie or the incoming call from Wendy) the communications system may access a database to determine call flow parameters. These parameters may indicate whether the incoming call is an initial call accessing the system (e.g., Suzie's initial call) or an incoming call that is responsive to a previous incoming call for the purpose of connecting to the incoming call (e.g., Wendy's call).

It is not necessary for Suzie to subscribe to any specific telecommunications service for this process to occur as described. However, as described, Wendy must be a subscriber to an incoming-call alert service to receive the SMS text message responsive to Suzie's initial incoming call.

At any time, Wendy (the called party) may optionally choose service options or attributes that control or effect the called party's and/or calling party's experience while using the service or thereafter. These attributes may include items such as:
1) Time(s) of day during which a call may (or may not) be accepted from the calling party and time(s) of the day when the called party may (or may not) return the call.
2) Day(s) of the week during which a call may (or may not) be accepted from the calling party and day(s) of the week when the called party may (or may not) return the call.
3) Black and white lists for individual phone numbers. A black list is a list of phone numbers that are always blocked, i.e., always blocking the calling party from accessing the called party (Wendy). A white list is a list of phone number that are always allowed access to the called party.
4) Options to allow the capture and retrieval of personalized voice message.
5) Service level options
6) Other attributes or options

According to another embodiment, the call can be completed by automated direct dial-out from the communications system 104 to the called party (Wendy). In this case, the system 104 may optionally send an SMS alert text that advises that a call is about to arrive at the called party's telephone number. Upon taking the incoming call, Wendy may hear an audio message informing her about the nature of the call. If the Wendy accepts the request for the call, the call is immediately completed.

As background for the next three described embodiments, a business, Joe's Phone Service, offers telecommunications services related to these embodiments. Joe's Phone Service customers subscribe to the service (e.g., through a web site or another subscribing method) and are assigned a telephone number and a PIN(s) as service subscribers. Wendy is a subscriber and Mary is an operator employed by Joe's Phone Service to handle various aspects of the telecommunications services provided.

### Embodiment 2

This embodiment of the invention is referred to as an “Actions by a Person” embodiment due to the requirement for actions by a person. However, as those skilled in the art are aware, the person may be replaced by various electronic and microprocessor-based devices to achieve the same results.

In this embodiment Wendy is using the system and its services to protect her identity and/or maintain her anonymity. All the actions necessary for setting up a single, two-leg phone conversation are performed by:
1) An originating telephone caller or the calling party (Suzie)
2) A responding telephone caller or the called party (Wendy)
3) A telephone operator (Mary)
4) A vintage patch-cord type PBX with
   1. caller ID features
   2. one dial-in line number and at least two additional telephone lines
   3. an operator's PBX headset
5) A music generator connected to one end of one of the PBX patch cords
6) A cell phone
7) A loose leaf folder containing printed system information

This operating scenario begins in a state with no active call legs or calls waiting in the PBX.

Suzie, a visitor to the United States from Japan, is helping her friend Harry to locate a stove to purchase. Neither Suzie nor Harry are subscribers to the services provided by Joe's Phone Services, and in fact are not familiar with the features and services associated with the presented embodiment. They are simply interested in purchasing a stove through an advertisement.

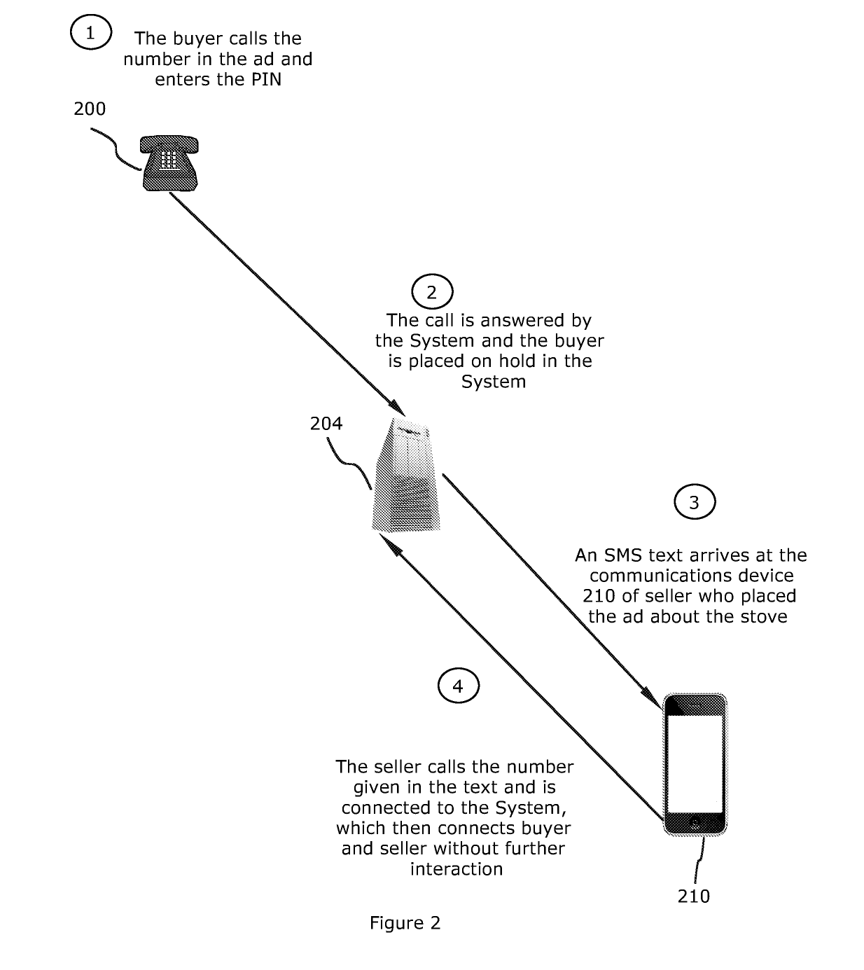

Suzie sees an advertisement for a stove in a newspaper or a trade publication or on a website, for example Craig's List. The advertisement includes a telephone number where the caller can receive additional information about the stove and also a PIN associated with the stove offer. At a step 1 of FIG. 2, Suzie calls the telephone number given in the advertisement (e.g., 321 555-1212) from a communications device 200.

The call is received at a communications device 204, which for this particular embodiment comprises a PBX. The PBX shows an incoming call on a line number 1 intended for telephone number 321 555-1212, i.e., the telephone number appearing in the advertisement. The PBX also indicates the telephone number that Suzie called from. This is considered a first leg of a call with the calling party intending to inquire about the stove for sale.

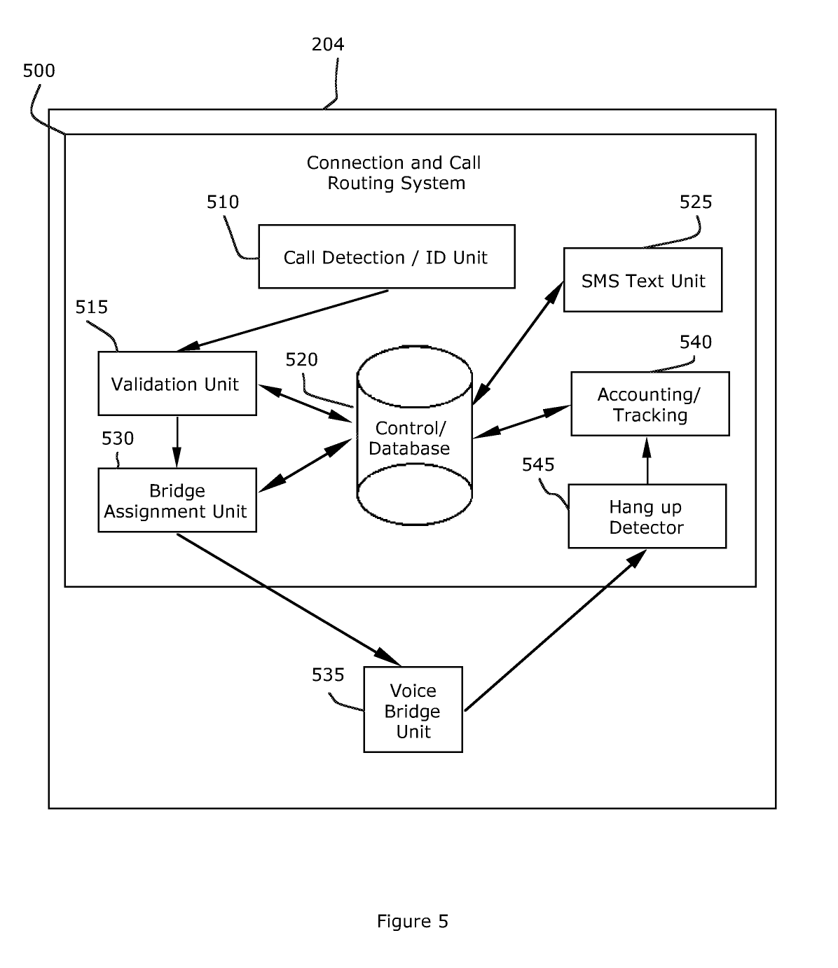

Referencing FIG. 5, a PBX 500 is an element of the communications system 204. The PBX and human operator together are performing the functions of a call detection/ID unit 510.

Mary is alerted to the presence of the incoming call on line 1. Note that in a situation where calls are waiting, Mary needs to determine more information about the incoming call. The scenario with calls waiting is described further below. Since there are no calls waiting according to this scenario, Mary patches her headset into line 1 to answer the call and request the PIN from the calling party. Suzie verbally provides the PIN, i.e., 234, the PIN associated with the stove for-sale advertisement.

Mary checks her system information and sees that PIN 234 is a valid PIN associated with a mobile phone number 805 555 1212. She checks the caller ID of the incoming call (e.g., 321 555 1212) and determines that the caller ID is not the caller ID assigned to the service subscriber of PIN 234. At this point Mary is performing the functions of a validation unit 515 and a control/database 520 of FIG. 5. Mary then determines and records:
1) arrival time of the incoming call
2) the PIN provided by the calling party
3) the telephone number associated with the PIN
4) the telephone number (caller ID) of the incoming call (from Suzie), if the caller ID is available for this call

Mary requests the calling party to remain on the line while she attempts to contact the person sought (i.e., the person selling the stove and associated with the PIN provided by Suzie).

Mary then un-patches her headset and patches music into the line on which Suzie is waiting. This action is equivalent to placing the call into a voice bridge unit 535 under control of a bridge assignment unit 530 of FIG. 5 that bridges the incoming call to recorded music. Mary then records the line number on which Suzie is waiting and the telephone number of the person Suzie is waiting for, i.e., the telephone number associated with PIN 234, which is 805 555 1212).

Mary consults her system information and notes that the owner/subscriber of the PIN 234 (with reference to the stove for sell) has chosen to be notified of incoming calls associated with PIN 234 by a text message.

Mary then uses a communications device (e.g., a mobile phone or another text message-enabled device) to send an SMS text message to Wendy at 805 555 1212. The message, may say, for example, “A Call Is Waiting About The Stove. Call back to 407 555 1212”. This step is indicated by a step 3 in FIG. 2 when the text message is received at Wendy's communications device 210. In an automated embodiment the SMS text unit 525 in FIG. 5 performs this step. The subscriber (Wendy in this case) can customize the content of the text message as desired.

In a situation where the PBX has only one call-in telephone, the number given in the SMS text message is the same number that Suzie called as appeared in the advertisement for the stove. If the PBX has more than one incoming telephone number, the number in the SMS text message to Wendy may be different from the number in the newspaper advertisement.

Mary now waits for an incoming call from Wendy or for an indication that the initial calling party (Suzie) has hung-up to terminate the call.

At step 4 of FIG. 2 Wendy calls into the communications system 204. Mary notes the caller ID of the incoming call. (Note, users of Joe's Phone Service are advised in advance that their caller ID must not be blocked to use the service. In a preferred embodiment, the caller ID information is always available, even if the caller attempts to block the caller ID.) Mary checks her list of waiting calls and sees that telephone line 1 (Suzie) is waiting for the caller with this caller ID (Wendy). Mary then patches this most recent incoming call directly to Suzie's line after terminating the music bridge connection.

Mary then records the details of the timing of the call for accounting and tracking purposes. In an automatic embodiment these actions are executed by a accounting/tracking unit 540.

A hang up detector 545 of FIG. 5 detects when a calling party has terminated the call by hanging up or breaking the connection.

Note that is not necessary for proper functioning of this embodiment for the identity of the person owning either telephone number (i.e., Suzie or Wendy) to be known by the communications system 204 and its incorporated PBX. The system functions using only the telephone number of the calling and called parties and the PIN assigned to the system subscriber.

In the scenario set forth above, it is not necessary for Mary to examine the state of the PBX and determine whether there are any waiting calls because it was initially assumed there are no waiting calls. Mary simply connects the party calling-in to the waiting caller to form a complete call.

However, in a real-life situation such is rarely the case as frequently incoming calls will be waiting to be patched to the appropriate called party when the called party contacts the PBX. Thus in the typical case, when a call arrives Mary must check her list of waiting calls and the called party for each waiting call. From the caller ID information she can determine the number of the calling party and thus can determine whether the calling party is a called party for one of the waiting calls or the calling party is an initial call from a party who wishes to be connected to one of the service subscribers. In the former case Mary merely connects the waiting calling party with the desired called party. It is not necessary for her to speak with either party. In the latter case, Mary answers the call and requests the PIN of the calling party as explained above.

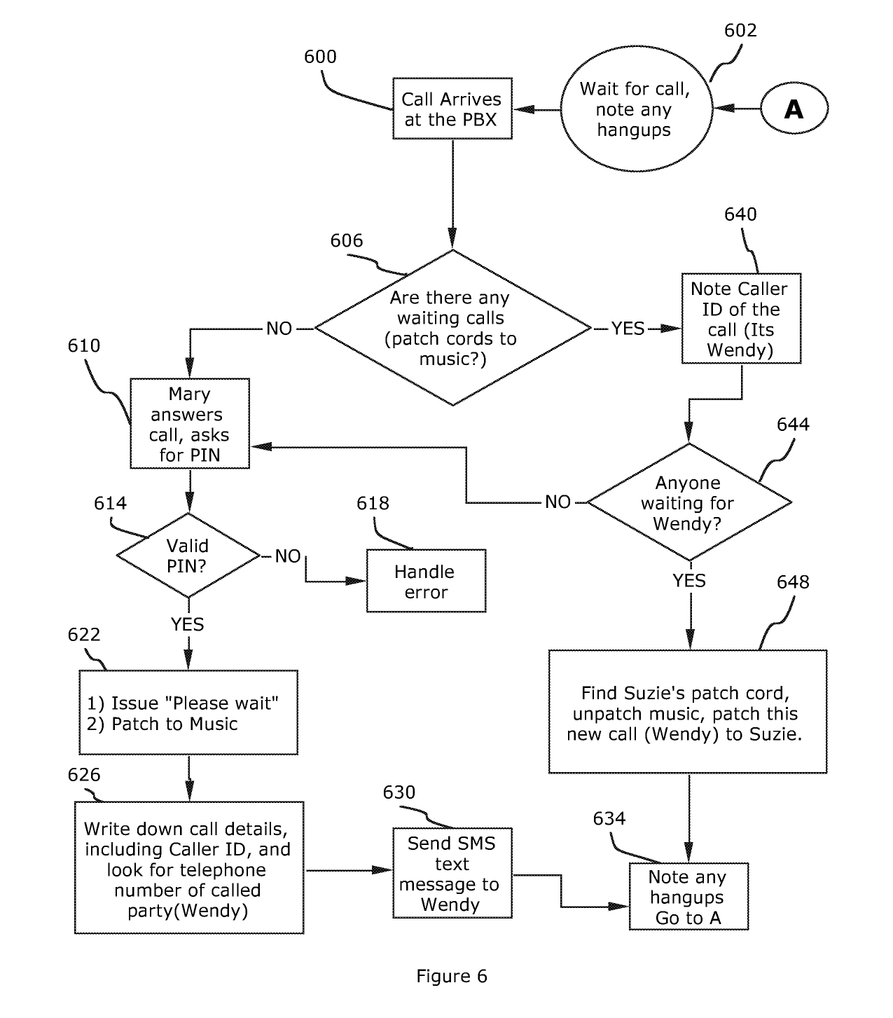

See FIG. 6 for a flow chart of this “Actions by a Person” Embodiment 2 of the invention.

A call (for example from Suzie) arrives at the PBX at a step 600. A note 602 merely indicates that prior to the arrival of a call, the PBX operator waits for calls and notes any call hang-ups.

A decision step 606 inquires whether there are any waiting calls that have been bridged (patched) to recorded music.

Following the “NO” path from the decision step 606, Mary answers the incoming call and requests a PIN at a step 610. At a decision step 614 Mary determines whether the PIN is valid. If the PIN is not valid processing progresses to a step 618 where the PIN error is noted and handled accordingly.

If the result from the decision step 614 is affirmative, at a step 622 Mary issues a “please wait” instruction and patches the calling party to recorded music.

At a step 626 Mary records call details, including the caller ID of the calling party and determines Wendy's (the called party) telephone number based on the PIN provided by the calling party.

At a step 630 Mary prepares and transmits a text message to the telephone number associated with the PIN (Wendy) supplied by the calling party (Suzie).

Step 634 indicates that hang-ups are continually monitored during the process. The process returns to the step 602 after the SMS text message is sent to Wendy.

When Wendy's call arrives (the step 600) processing then progresses to the decision step 606. Now the answer is affirmative and the “YES” path is taken.

At a step 640 the caller ID of the incoming call is determined. The outcome at a decision step 644 is affirmative since Suzie is waiting for the call from Wendy.

At a step 648 Suzie is unpatched from the music and patched to Wendy's incoming call. This now places the potential stove buyer in communications with the stove seller.

The step 634 is then executed, i.e., calls are continually monitored and the process returns to A.

Although the attributes of this embodiment have been described using a vintage patch cord system and a human operator, those skilled in the art recognize that various electronic devices can implement the same features. FIGS. 2 and 6 illustrate the principal features of this embodiment, whether implemented with human efforts or automatically by electronic devices.

Also, in an embodiment where there are: (1) multiple locations where the system can receive incoming calls (e.g., in several states), (2) multiple dial-in numbers at each location, (3) multiple servers (bridges, for example) for each dial-in number, the dial-in number can be used to associate the entered PIN with a user (Wendy). In this case there may be many users with the same PIN but each has a different dial-in number and thus the association between a PIN and a dial-in number can be determined.

### Embodiment 3

In the third embodiment, also referred to as the “All In One” embodiment, Wendy protects her identity when the telephone call is established. All activities necessary for single or multiple users of the embodiment are performed by a single computer/server (“Server”) with attendant Internet connections, etc. The server connects to a local or public internet, and may also connect to a VoIP gateway. The “All In One” embodiment is capable of handling multiple simultaneous two-leg telephone conversations.

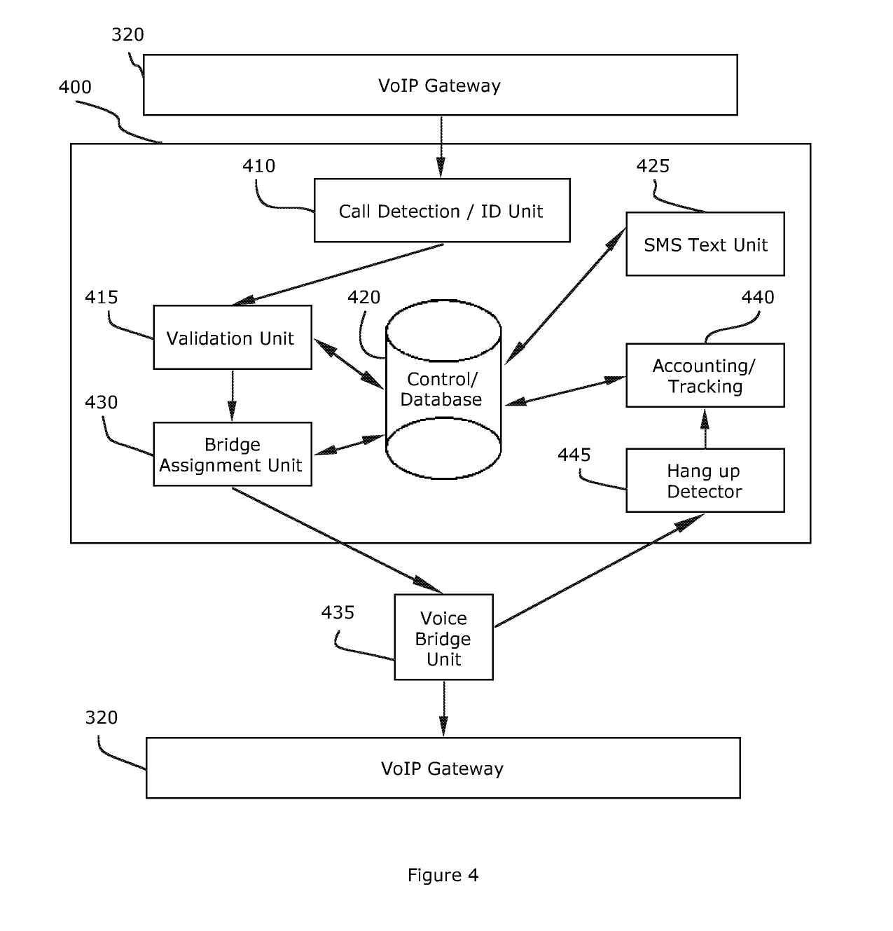

Referencing FIG. 4, the various operations associated with this embodiment are executed by a connection and call routing system 400, which may be an element of a server not shown.

The following scenario describing the “All In One” embodiment begins in a state where the connection and call routing system 400 is not storing any active call legs. At the start of this scenario, a member of the public (e.g., Suzie), who may or may not be a subscriber to the service or a provider using the elements of the embodiment, places a telephone call.

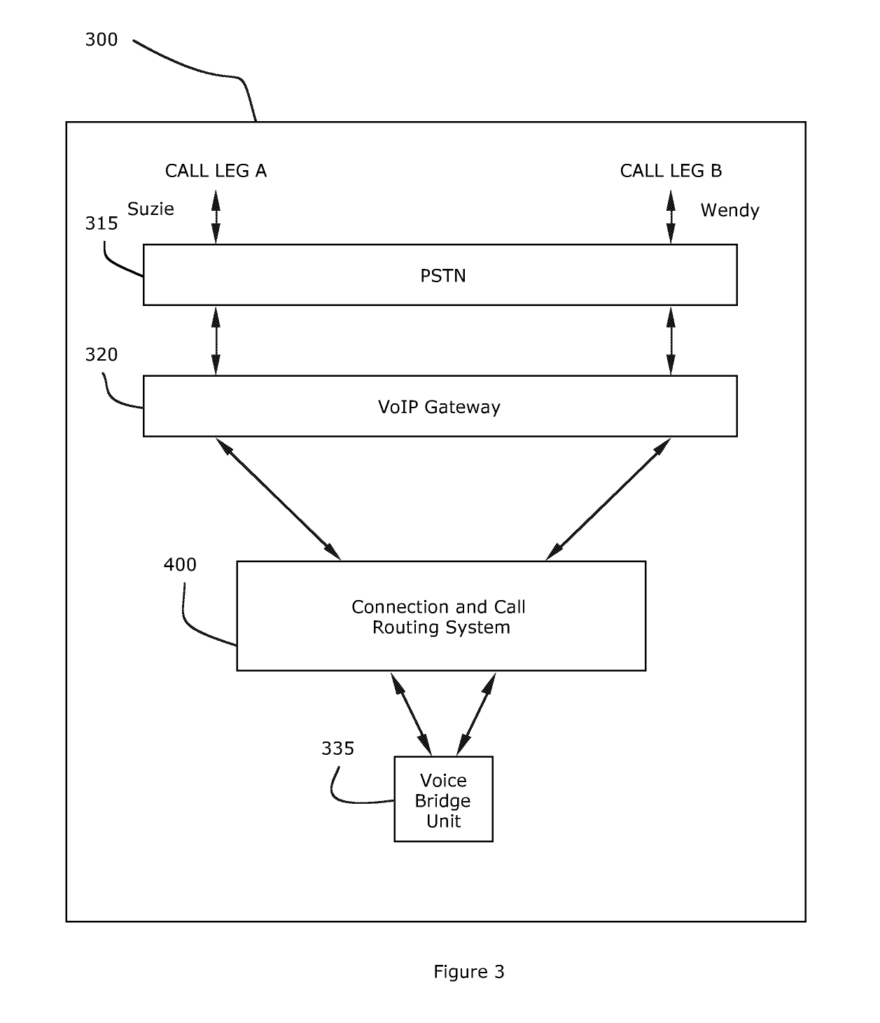

Referencing FIG. 3, Suzie places a call from her phone; the call enters a PSTN 315. In this embodiment, a telecommunications services supplier receives the call via the PSTN 315 and translates the call by use of VoIP gateway 320 into a VoIP telecommunications event. The aforementioned telecommunications event can be achieved using the SIP (session initiation protocol) VoIP signaling protocol, or any similar method using network signallig technology, such as H.232, IAX (inter-asterisk exchange), RVP (remote voice protocol) or MGCP (media gateway control protocol).

The telecommunications supplier delivers the telecommunications event to the connection and call routing system 400 of FIG. 4, the elements of which are shown in detail in FIG. 4.

Referencing FIG. 4, a call detection/ID unit 410, an element of the connection and call routing system 400, while monitoring an Ethernet port of the server, receives and recognizes the telecommunications event as a request to initiate a call. The call detection/ID unit 410 passes the information from the event to a validation unit 415. The validation unit 415 comprises a supervisory computer program (“Supervisor”) that contacts a control/database 420 with the telecommunications event or other VOIP channel number of the incoming call, the caller ID if present, the time of day, and other pertinent information as desired.

The control/database 420 returns a response to the supervisory computer program. This response (“Response One”) may have the following possible meanings in this embodiment:
1) The number zero (0) means:
   this number (i.e., the number as determined by the caller ID) has not been blocked by anyone,
   no one is waiting for this number to establish a conversation, it is permissible to request a PIN from the caller (Suzie).
2) The number two (2) means:
   this number is on a block list,
   handle the call according to the policy in place (e.g., dump the call),
3) The number one (3) means:
   there has been a system error and play a busy signal (i.e., busy back the line to Suzie's phone).
4) Any other number represents the SIP or other VOIP channel number, meaning:
   a call is waiting for this leg to arrive,
   the PBX channel number received from the control/database 420 is the channel number holding on the system. Bridge together the new incoming call leg with the leg holding in the system to establish voice communication between the parties.

The number designations and meanings given in the above exemplary response are intended to represent one possible embodiment. Other techniques for controlling call flow to achieve the purpose of the embodiment are possible, as is known to those skilled in the art.

Returning to the exemplary call from Suzie, at this point, the leg 1 call from Suzie has arrived at the connection and call routing system 400. This calling number has not been blocked, and the control/database 420 returns a (0) to the supervisory computer program.

Responsive to the returned (0), within the validation unit 415 the supervisory control program initiates a voice message to the caller, such as “Welcome to Joe's Phone Service. Please enter your PIN followed by the pound sign.” The supervisory control software resident in the validation unit 415 then uses DTMF or similar technology to decode the digits of the PIN. The supervisory control program sends this PIN, the telecommunications event channel number and caller ID, if any, back to the control/database 420.

The control/database 420 checks its stored data to ensure the PIN is a valid PIN and it is permissible to attempt to connect Suzie to Wendy. If PIN is deemed valid, the control/database 420 contacts an SMS text unit 425 with Wendy's SMS destination information and the text message to be sent to her.

The SMS text unit 425 uses the Internet or another communications medium to contact an SMS originating service, and sends the SMS text using one of many available protocols over an SMS text network. In one embodiment the protocol comprises an HTTP API provided by the party providing the SMS service.

To summarize to this point, Suzie has dialed in and entered a valid PIN. An SMS text has been sent notifying Wendy advising her that someone is waiting to talk to her (e.g., on hold). Additional text, as previously specified by Wendy, can also be sent in the same SMS text message. In this example, Wendy specified ‘About the stove’ as the additional text to be included in the text message sent to her when someone calls her and enters the PIN associated with the stove offered for sale.

In this embodiment, after the control/database 420 sends the SMS text message (without error, as more than one attempt may be required) it returns a simple response code to the supervisory control program at 415. This response (“Response Two”) has the following possible meanings in this example:
1) The number zero (0) means:
   the PIN is invalid,
   handle the error according to policy (e.g., ask for the PIN again).
   2) The number one (1) means:
   the PIN is valid, but the customer has the service turned off, handle according to policy (e.g., issue an appropriate voice message).
3) The number two (2) means:
   the customer is busy on another line,
   handle according to policy (e.g., issue a ‘please wait’ message).
4) the number three (3) means:
   the customer has instructed the service to send all calls to voice mail,
   handle according to this customer's instructions.
5) the number four (4) means:
   system error,
   handle according to policy.
6) Any other number represents a bridge holding area identifier.

In the case of a single server implementation of the embodiment, this could be a MeetMe room identifier (“RoomID”) created and implemented using known conference bridging software.

The conference bridge comprises any device composed of software, hardware, telecommunications equipment, and/or any other devices or inventions, for joining the audio communications of two or more sources into a commonly shared audio experience available to all the parties interested in, and/or authorized to join, the communications.

The values and meanings given in the above response are meant to be representative of only one possible embodiment. Other schemes for controlling the call flow to achieve the purposes of the embodiment are known to those skilled in the art.

To this point in this example, Suzie has called in and entered a valid PIN, and the PIN's owner (Wendy) has configured the system to attempt to connect Suzie for direct voice communications with Wendy. The validation unit 415 now has:
1) the SIP channel number
2) the caller ID if available
3) the PIN
4) the RoomID (if applicable)

Again within the validation unit 415, the supervisory control program sends the above information to a bridge assignment unit 430. In this single server implementation, the bridge assignment unit 430 sends the SIP audio channel to the MeetMe room, that is, a voice bridge unit 435.

To this point in the example, Suzie is listening to music on hold from the voice bridge 435.

Wendy receives the SMS text message on her communications device as sent over the SMS network. The text message may say, “A Call Is Waiting About The Stove. Call Back 407 555 1212”. Wendy then calls the number given in the SMS text message.

Referencing FIG. 3, Wendy calls the number to set up a call leg B. The call passes through the PSTN 315, is routed through the VoIP gateway 320, in this case converted to an SIP session, and arrives at the connection and call routing system 400.

Referencing FIG. 4, Wendy's call arrives at the call detection/ID unit 410 as an SIP request to initiate an SIP session. As with Susie's call, the unit 410 passes the information gathered from the SIP event to the supervisory control program in the validation unit 415. The supervisory control program contacts the control/database 420 with the SIP channel number of the incoming call, the caller ID if present, the time of day, and other information. As previously described, the Response One returns a simple control number as the result.

In this case of Wendy's return call to the system as a result of the text message she received, Response One contains the code representing the SIP channel number on which Suzie is waiting. Receiving this information, the system knows not to answer the call, but instead to route Wendy's incoming call directly to the voice bridge unit 435 and there join Suzie and Wendy in voice communication.

The hang up detector 445 of FIG. 4 has the same basic functionality as the hang up detector 545 of FIG. 5.

### Embodiment 4

In the fourth embodiment, also referred to as the “Distributed” embodiment, Wendy again wishes to protect her identity when a telephone call is established with her. However, in this embodiment all the tasks necessary for single or multiple users of the embodiment may be performed by multiple computers, servers, software databases, software bridging devices and, as required, software conference call devices and/or servers, unlike the single server configuration of embodiment 3.

Embodiments 3 and 4 relate to the purchase of an item, such as a stove, by the calling party. However, the principals of the invention can also be used in other contexts, such as dating services and the provision of other services to the general public, such as legal or accounting services. In such situations the IDN and PIN numbers may be identified in an advertisement, or on a business card of a party providing the desired services.

### Embodiments 5, 6 and 7

Embodiments five, six and seven examine two additional applications of the same invention while blending these two additional applications at the same time. In these three embodiments Harry owns Harry's Nationwide Plumbing Company (or another merchant). Harry engages Joe's Phone Service to provide the necessary functionality.

### Embodiment 5

In this embodiment five, Harry wishes to provide 24-hour emergency service for some or all of his customers. However, Harry wants only one of his employees to be ‘on call’ each night. For example, on Mondays Harry wants Steve to receive all after-hours calls. On Tuesday the after-hours calls go to Bill and Wednesday's after hours calls go to Silvia.

To accomplish this objective, Harry purchases the services of a company such as Joe's Phone Service. Joe's Phone Service issues Harry's company a telephone number and a PIN.

Harry gives this telephone number and PIN to each of his customers needing 24-hour emergency service. Alternatively, Harry publishes the telephone number and PIN in an advertisement stating that he provides 24-hour repair service. Such an ad may appear in the telephone yellow pages, for example. In any case, one of Harry's potential or existing customers finds the telephone number and PIN and uses these to contact Harry's company as follows.

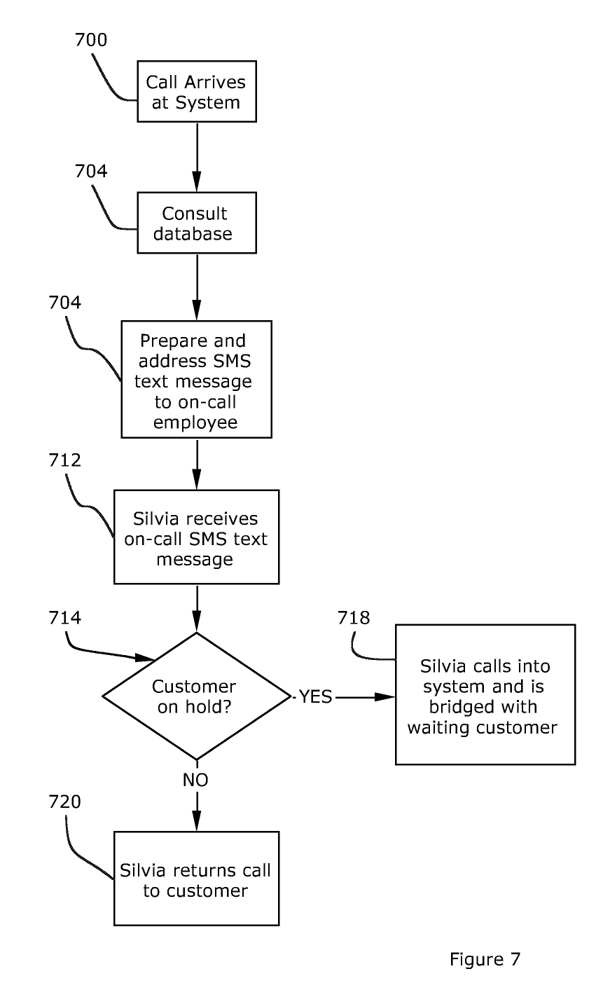

FIG. 7 depicts a flowchart for the system. A call arrives at a step 700 on a Wednesday and the system consults a database or other source of system information at a step 704. This information informs the system, based upon the day and time of the incoming call, which one of Harry's employees is assigned to take the call. After making this determination, the system addresses the alerting SMS text message to the on-call employee and sends the SMS text message at a step 708. Assuming Silvia has been assigned to receive the Wednesday after-hours calls, Silvia receives the text message on her communications device (e.g., a mobile phone) at a step 712.

If the customer was waiting on hold, a path from a decision step 714 proceeds to a step 718 where Silvia calls into the system and is bridged to the holding customer to talk directly with the customer.

If the customer is not waiting on hold, from the decision step 714 the process continues to a step 720 where Silvia calls the customer back.

Note that Harry may be issued multiple PINs by Joe's Phone Service. These other PINs, may, for example, be used to segregate the incoming calls based on the type of item that the customer needs to have repaired. Thus the customer enters the PIN associated with the item to be repaired and in this way Harry ensures that the responding party is familiar with the operation and functionality of that item. For example, refrigerator and cooler repairs may be assigned PIN 4567 and the system contacts Tim, who is a refrigeration expert, to take the customer's call. HVAC (heating, ventilating and air conditioning) repairs are associated with PIN 7890. If the customer enters this PIN the system contacts Ed to handle the service call.

### Embodiment 6

According to this embodiment, Harry has five offices across the United States, and advertises on television during a popular nationwide program, such as the NFL Super Bowl. Harry desires to: 1) track the source of calls from his national advertising campaign and 2) allow incoming calls to be answered by the office closest (geographically) to the caller. In another embodiment, instead of the advertising campaign limited to a particular television program, the advertising campaign may extend to multiple advertisements in multiple media over a limited time interval. Again, Harry can determine the effectiveness of the campaign by assigning a PIN to each ad appearing in any media during the limited time interval.

In this scenario again, we assume Harry has hired Joe's Phone Service. Joe's Phone Service has provided Harry with a unique PIN that will be seen on TV only during the Super Bowl and at no other time.

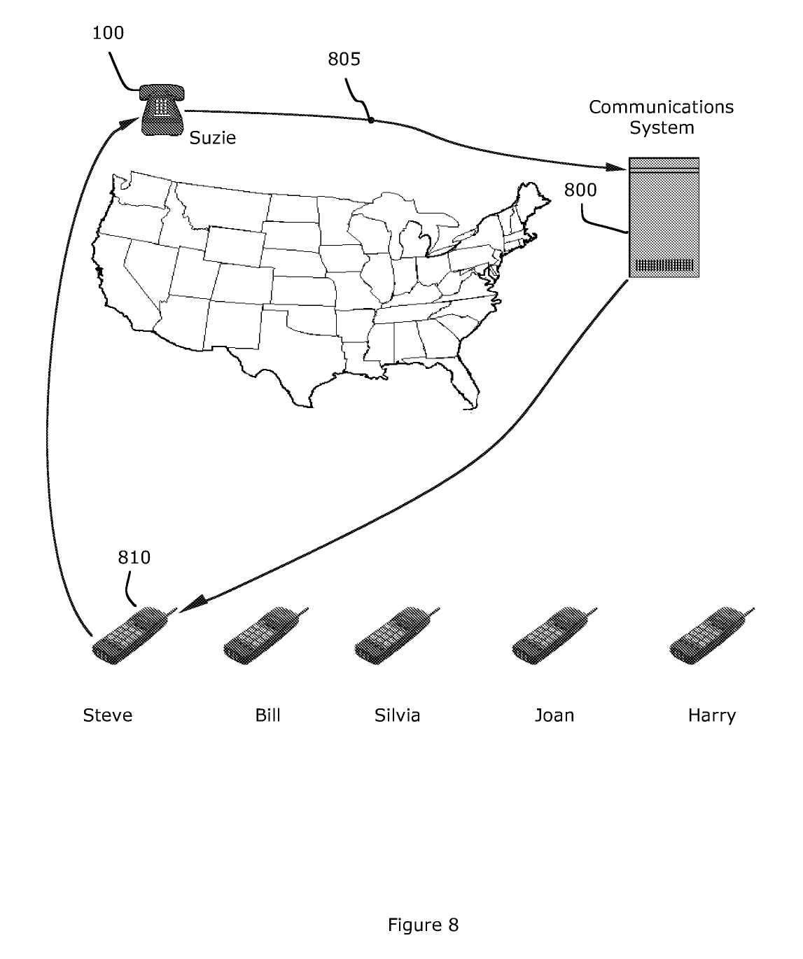

Referencing FIG. 8, Suzie on the West Coast is watching the Super Bowl and see's Harry's television advertisement that includes Harry's telephone number and PIN. Suzie uses the communications device 100 to call (as indicated by the reference character 805) the telephone number given in the advertisement. The call arrives at the system 800. Suzie then enters the PIN given in the advertisement.

The system checks the telephone number of the incoming call. In this case, Harry's Nationwide Plumbing has exclusive use of this number, so the system determines from a look-up table, for example, that the call is for Harry's Nationwide Plumbing.

Using the PIN as an index into another look-up table (in essence a database) (alternatively, another method can be used, such as a hard-coded association) the system determines a unique custom SMS text message to be associated with this call. In this case, the message may be “Response to the Super Bowl ad.”

Also in this case, Joe's Phone Service's telephony hardware is located within an ILEC (incumbent local exchange carrier) or CLEC (competitive local exchange carrier) that provides incoming caller ID information to Joe's Phone Service, even when the caller ID system is blocked.

The system 800 uses the caller ID information to determine which one of Harry's Nationwide Plumbing offices is geographically closest to the location of the incoming caller. This determination can be a best-guess based on the area code of the caller from the caller ID information. This determination can also be made using other techniques. For example, the system can access in real-time a nationwide database of telephone numbers at the time the call is received. This database, which can be used to deal with number portability issues, may generate a more accurate approximation of Suzie's location.

Based on the results of these look-up actions using the PIN and caller ID, the correct unique text message is delivered to the closest outlet of Harry's Nationwide Plumbing. In this case, an outlet 810 managed by Steve.

### Embodiment 7

In embodiment seven, Harry advertises nationwide during a given program as in embodiment 6. In this case however, Harry not only wants to route the call to his closest office, Harry also wants programmable control over the employee at the destination office who receives the SMS alert of the incoming call.

The criteria for employee selection could be as simple employees rotating on-call days. Alternatively, Joe's Phone Service may allow more control over the SMS notifications. For example, the system can be configured to rotate calls one at a time among all employees at a particular office (regardless of the day of the week). Or in another embodiment different offices may have different policies about the mechanism by which calls are distributed among its employees. Unusual configurations can also be designed and implemented. For example, Harry may want the New Orleans office to take all of Los Angeles' calls on alternate Tuesdays.

Thus embodiment 7 blends the various controls suggested in the previous embodiments to provide greater control over the methodology by which Harry's incoming call are handled.

### Embodiment 8

This embodiment relates to a method that allows a credit card user to instantly approve use of the credit card. This embodiment can be effective to reduce fraudulent use of stolen credit cards.

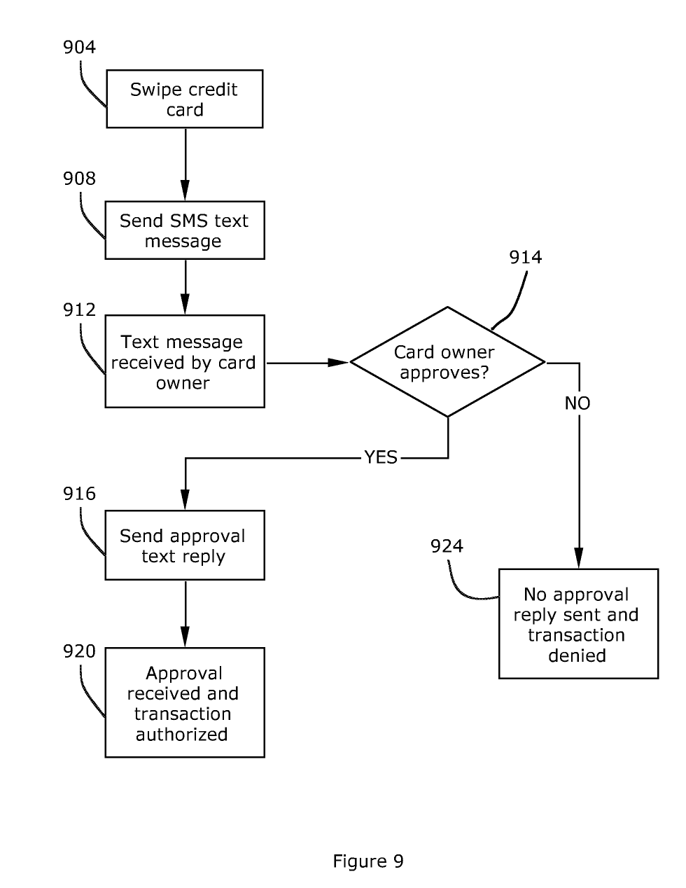

A credit card is swiped at a point-of-sale terminal for authorization of a transaction at a step 904 of FIG. 9. Responsive to the swiping action, details of the transaction, including at least the credit card number and the amount to be charged to the card, are electronically transmitted to an issuing bank or cardholder service provider. At a step 908, the authorization process continues by sending an SMS text message to a telephone number previously selected by the party to whom the credit card was issued. This text message is sent by the card-issuing bank, cardholder service provider or another party responsible for authorizing the transaction and received by that party at a step 912.

A decision step 914 represents an approval decision by the card owner.

If use of the credit card is legitimate, the process proceeds from the decision step 914 to a step 916 where the card owner sends an approval reply SMS text message. At a step 920 the approval is received and the transaction authorized.

If the result from the decision step 914 is negative, the process continues to a step 924 where the transaction is denied as the approval reply was not received.

The SMS text message sent at the step 908 may include one or more of a credit card number, an identification of the party to whom the credit card was issued, a purchase amount, etc. The reply approval sent at the step 916 may be a simple reply “yes” or “no” or may include passwords or similar identity schemes. Lack of a reply message also indicates that use of the credit card was not approved by the card owner.

Additionally, a mobile phone application may be used to pre-program the conditions for an approval, or facilitate the approval process in other ways, such as using a single-click method on the mobile phone to indicate approval of the transaction by the party to whom the card was initially issued.

### Embodiment 9

In certain circumstances, such as certain ones of the embodiments described above, it may be desirable to determine contact information (such as a telephone number or an SMS text message destination) from a telephone number of an incoming call (determined using a callerID technique) and a PIN entered by the party placing the incoming call. For example, a database may be consulted using the telephone number of the incoming call and the PIN as indices into the database to determine the telephone number or the SMS text message destination.

In certain applications and embodiments described above the BRG is not capable of making an outbound call. In other applications and embodiments a server, conventionally referred to as an Asterik box or Asterik logic, contains multiple bridges. The Asterik box also includes programmable logic to originate outbound calls and do so while a party is waiting at a bridge. When the outbound call is answered, the Asterik logic transfers both call legs to a bridged conversation.

The presented embodiments can be embodied in the form of computer- implemented processes and apparatus for practicing those processes. The presented embodiment can also be embodied in the form of computer program code containing computer-readable instructions embodied in tangible media, such as floppy diskettes, CD-ROMs, hard disks, or any other computer-readable storage medium, wherein, when the computer program code is loaded into and executed by a computer or processor, the computer or processor becomes an apparatus for practicing the embodiments. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer or processor, the computer or processor becomes an apparatus for practicing the invention. When implemented on a general-purpose computer, the computer program code segments configure the computer to create specific logic circuits or processing modules.

Although the embodiments have been shown and described with respect to a certain preferred embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component that performs the specified function of the described component (i.e., that is functionally equivalent), even though not structurally equivalent to the disclosed structure that performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A method for completing a telephone call between a first party and a second party, the first party placing a first call to a first telephone number, the method comprising:
receiving the first call;
determining, based on a characteristic of the first call, that the first call is intended for the second party, an identity of the second party anonymous with respect to the first party;
contacting the second party and advising that the first party attempted to contact the second party;
receiving a second call from the second party responsive to the step of contacting; and
connecting the first and second calls to connect the first and second parties in a telephone call.

2. The method of claim 1 further comprising placing the first party on hold prior to the step of contacting the second party, and wherein the step of contacting the second party comprises sending a text message to the second party.

3. The method of claim 2 wherein the text message includes one or more of a second telephone number to which the second call should be placed, a reason for the first party placing the first call, and the first telephone number.

4. The method of claim 1 wherein the second party is a subscriber to a service for implementing the method for completing the telephone call.

5. The method of claim 1 wherein the first party enters a PIN after placing the first call.

6. The method of claim 5 wherein the characteristics of the first call comprise one or more of the PIN, the first telephone number, and a conference bridging device number.

7. The method of claim 5 further comprising a step of determining a second telephone number responsive to at least one of the first telephone number and the PIN, the second call to the second telephone number.

8. The method of claim 1 wherein the first call establishes a first call leg and the second call establishes a second call leg, and wherein the step of connecting further comprises connecting the first and second call legs to connect the first and second parties in a telephone call.

9. The method of claim 1 further comprising determining whether the first call comprises a call from the first party or comprises a call from the second party for connecting to the first party.

10. The method of claim 1 further comprising accessing stored database information prior to receiving one or both of the first and the second calls to determine call flow parameters.

11. A method for determining contact information of a communications device, the method comprising:
receiving an incoming call from a first telephone number not associated with the communications device at a second telephone number;
receiving a PIN from the first telephone number; and
determining the contact information responsive to one or more of the first telephone number, the second telephone number and the PIN.

12. The method of claim 11 wherein the communications device comprises one of a telephone and a text-message capable device and the contact information comprises, respectively, a third telephone number and a text message destination address.

13. The method of claim 12 further comprising sending a text message to the text-message capable device, and wherein a content of the text message comprises one or more of the first, second and third telephone numbers, and wherein the text message alerts a party to call the third telephone number.

14. The method of claim 12 further comprising assigning a PIN to a first person or a first business and providing a second person with the second telephone number and the PIN for the purpose of contacting the first person or the first business, the steps of assigning and providing executed prior to the step of receiving the incoming call, wherein the incoming call is placed by the second person.

15. The method of clam 14 further comprising executing a response to the second person responsive to the PIN, wherein the response has been predetermined by the first person.

16. A method for handling a first telephone call placed by a first party to a first telephone number, the method comprising:
the first call traversing a communications path with at least a segment of the communications path comprising a public switched telephone network;
receiving a PIN entered by the first party;
responsive to the first telephone number and the PIN determining the call is intended for a second party, an identity of the second party anonymous with respect to the first party; and
responding to the first party according to one or more predetermined responses as determined by the second party prior to the first party placing the first call.

17. The method of claim 16 wherein the predetermined responses comprise one or more of:
advising the second party of the first call;
placing the first party on hold and advising the second party that the first party is waiting on hold;
requesting the second party to call a second telephone number and thereafter connecting the first and second parties; and
playing a recorded message to the first party.

18. The method of claim 16 wherein the first call relates to a service or goods sought by the first party from the second party.

19. The method of claim 16 wherein the PIN is made publicly available by the second party in relation to the service or goods provided by the second party.

20. The method of claim 16 wherein at least one of the predetermined responses is responsive to a telephone number from which the first call was placed.
